(19) United States
(12) Patent Application Publication
(10) Pub. No.: US 2013/0093552 A1
(43) Pub. Date: Apr. 18, 2013

(54) Neodymium-Iron-Boron Magnet having Gradient Coercive Force and its Preparation Method

(71) Applicants: Qingkai Wang, Yantai (CN); Yongjiang Yu, Yantai (CN); Ning Guo, Yantai (CN)

(72) Inventors: Qingkai Wang, Yantai (CN); Yongjiang Yu, Yantai (CN); Ning Guo, Yantai (CN)

(21) Appl. No.: 13/806,762

(22) PCT Filed: Dec. 24, 2010
(86) PCT No.: PCT/CN2010/080243

§ 371 Date: Dec. 22, 2012

(30) Foreign Application Priority Data
Jun. 30, 2010 (CN) 201010213887.4

(51) Int. Cl. H01F 1/01

(52) U.S. Cl. CPC H01F 1/01
USPC 335/302; 419/38

(57) ABSTRACT

A neodymium-iron-boron (NdFeB) magnet having gradient coercive force and its preparation method are disclosed. The NdFeB magnet includes at least two NdFeB material layers having different coercive force, including an exterior layer having high coercive force and at least a medial layer having low coercive force. The exterior layer is connected to the medial layer via a sintered layer along an orientation direction. The NdFeB magnet has high magnetic properties and high resistance to magnetism loss.

### CROSS REFERENCE OF RELATED APPLICATION

This is a U.S. National Stage under 35 USC 371 of the International Application PCT/CN2010/080243, filed on Dec. 24, 2010.

### BACKGROUND OF THE PRESENT INVENTION

1. Field of Invention

The present invention relates to a permanent magnet material of neodymium-iron-boron (NdFeB), and more particularly to a NdFeB magnet having gradient coercive force and its preparation method.

2. Description of Related Arts

Rare earth permanent magnet of NdFeB is increasingly and widely applied in nuclear magnetic resonance, computers, hybrid power vehicles and various kinds of electric motors and wind generators because of good magnetism. According to different application fields, performances and constituents of the NdFeB permanent magnets are distinctively different. Usually the NdFeB magnet made of Pr and Nd has a relatively low coercive force and poor resistance to reversing magnetic field and high temperature, and is readily demagnetized, so the NdFeB magnet made of Pr and Nd can be applied only in environment of low reversing magnetic field and not so high temperature. However, by adding rare earth elements such as Dy and Tb into the magnet, the coercive force thereof can be effectively improved; the resistance to high temperature and reversing magnetic field of the magnet is also improved. In recent years, with the rapid development of industries such as hybrid power vehicles and wind generators, the needs for such a magnet resistant to high temperature also multiply increase.

However, such a magnet also has obvious disadvantages. Firstly, with the increasing of Dy and Tb, surface magnetic field and energy products thereof are also relatively greatly decreased. For electric motor, if the energy products are reduced, more magnets would be needed to output identical power and thus the volume and weight thereof are accordingly increased. Furthermore, Dy and Tb belong to scarce sources, prices are several times, even more than ten times of PrNd alloy, which also limits a wider application of such magnets.

In a test of 46H magnet (Hcj=17.8 KOe) at a temperature of 150° C., results show that the permanent magnet is demagnetized unevenly in the electric motor; for a permanent magnet sticking to a magnetic yoke, the magnet always has the surface close to the induction coils demagnetized and the internal part basically unaffected; and for a magnet embedded into silicon steel sheets, the magnet always has two external surfaces demagnetized. This is because the part of the magnet close to the coils bears a much stronger reversing magnetic field than the internal part does; and for the bonded permanent magnet, one side of the magnet close to the coils has a higher temperature than the other side thereof because of vortex and others.

The electric motor usually works at a temperature of more than 150° C. If the magnetism loss of a magnet is required to be relatively less, it is necessary to use magnets having coercive force over 20 KOe. Thus magnets having higher coercive forces, 40SH and 38UH, are tested at a temperature of 150° C. Results show that magnets having higher coercive forces are demagnetized very slightly. This is because a higher coercive force means a better resistance of the magnet to magnetism loss; however, the higher coercive force also leads to lower energy products and an obviously less output of the electric motor. In order to stabilize the surface magnetic field of the magnets in the electric motor, more magnets are needed, which also increases cost.

### SUMMARY OF THE PRESENT INVENTION

An object of the present invention is to provide a NdFeB magnet having gradient coercive force, high magnetism and high resistance to magnetism loss and its preparation method.

A preparation method of the present invention comprises following steps of:

(1) preparing at least two alloys having components of R—Fe—B-M, wherein the alloys comprise at least alloy A and alloy B; R contains at least one rare earth element selected from Pr, Nd, Dy and Tb; M contains one or two more elements selected from Co, Cu, Ga, Nb, Al, Mn, Zr and Ti; and the weight percentage of M is below 5%, and the content of Dy and Tb in the alloy A is higher than the content of Dy and Tb in the alloy B, and the content of Dy and Tb in the alloy B is higher than the content of Dy and Tb in other alloys;

(2) pulverizing the alloy obtained from the step (1) into powder via a pulverizing device by at least one of following preparation methods of:

(a) putting alloy flakes respectively into a hydrogen treatment furnace for a hydrogen pulverization in a protective environment of inert gas or N₂ and then into a jet mill for a fine pulverization; and

(b) grinding and pulverizing alloy flakes respectively and then processing the alloy flakes with a fine pulverization via a jet mill;

(3) molding the powder obtained from the step (2) in a magnetic orienting and molding device, wherein at least one separating board is pre-provided therein; the powder is respectively filled into different separated cavities; and the separating board is removed until the powder filling is finished, wherein the powder made of the alloy A is filled into at least an external cavity; and

(4) sending the compact into a sintering furnace to be sintered at 1000° C. to 1120° C. for 1 hour to 6 hours and subsequently processing with aging treatments at 850° C. to 950° C. for 1 hour to 6 hours and at 450° C. to 600° C. for 1 hour to 6 hours, so as to obtain a NdFeB magnet having gradient coercive force.

In the preparation method of the present invention, particle size after fine pulverization of the step (2) is between 3 μm and 4 μm.

In the preparation method of the present invention, the step (3) further comprises filling the powder obtained from the step (2) layer by layer along an orientation direction and compacting the filled power in a magnetic field for alignment, wherein the powder made of the alloy A is filled into an external layer of at least one side.

In the preparation method of the present invention, the percentage of the thickness filled by the powder made of the alloy A in the step (3) is below 50%.

In the preparation method of the present invention, the magnetic orienting and molding device of the step (3) has a protection of inert gas or N₂, or has the powder added with antioxidants.

A NdFeB magnet having gradient coercive force of the present invention comprises at least two NdFeB magnetic material layers having different coercive forces, comprising a first exterior layer having high coercive force and at least one medial layer having low coercive force, wherein the first exterior layer having high coercive force is connected to the medial layer having low coercive force via a sintered layer along the orientation direction.

In the NdFeB magnet having gradient coercive force and its preparation method of the present invention, a plurality of the medial layers having low coercive force are connected with each other via the sintered layer along the orientation direction.

In the NdFeB magnet having gradient coercive force and its preparation method of the present invention, a second exterior layer having high coercive force is further comprised, wherein the second exterior layer having high coercive force is connected to the most external medial layer having low coercive force via the sintered layer along the orientation direction.

In the NdFeB magnet having gradient coercive force and its preparation method of the present invention, the first exterior layer and the second exterior layer are made of identical materials.

In the NdFeB magnet having gradient coercive force and its preparation method of the present invention, the ratio of a sum of thickness of the first exterior layer and the second exterior layer to a total thickness is below 50%.

The present invention provides a NdFeB sintered magnet with at least two layers having different coercive force. Compared with a conventional whole piece of magnetic steel, the NdFeB magnet having gradient coercive force has vortex loss greatly reduced. Besides, the first exterior layer and the second exterior layer of the NdFeB magnet having gradient coercive force have better resistance to high temperature; and thus the NdFeB magnet having gradient coercive force has effective resistance to high temperature and reversing magnetic field during processes of installing at high temperature and device operation, so as to reduce thermal magnetism loss and improve working environment of the medial layers of the magnet. Thereby, the medial layers of the magnet can be made of magnetic steel having low coercive force and high remanence, which not only reduces usage amount of heavy rare earth elements such as Dy and Tb, material costs and waste of resources, but also improves the total remanence of the combined magnetic steel, so that the medial layers can be made of magnetic steel of relatively smaller volume.

These and other objectives, features, and advantages of the present invention will become apparent from the following detailed description, the accompanying drawings, and the appended claims.

### BRIEF DESCRIPTION OF THE PREFERRED EMBODIMENT

### Embodiment 1

### 48H-42SH NdFeB Magnet Having Gradient Coercive Force

Raw materials having a component of Nd₂₀Pr_{5.5}Dy_{4.5}Co₂Cu_{0.15}Ga_{0.1}Al_{0.2}B₁Nb_{0.1}Feᵣₑₛₜ are smelted to form an alloy A in a vacuum strip continuous casting furnace, and raw materials having a component of Nd₂₁Pr₆Dy_{2.5}Co₁Cu_{0.1}Ga_{0.1}B₁Nb_{0.1}Feᵣₑₛₜ are smelted into an alloy B in the vacuum strip continuous casting furnace. Then flakes of the alloy A and the alloy B are respectively processed with hydrogen pulverization in a hydrogen treatment furnace, and thereafter, in a protective anaerobic environment of N₂, processed with fine pulverization via a jet mill to produce powder having a particle size of 3.6 μm.

The powder is molded in a vertical magnetic orienting and molding device having an environment containing oxygen below 1%, wherein a copper separating board having a length of 71.9 mm, a height of 105 mm and a thickness of 0.5 mm is pre-provided in a molding cavity having a length of 72 mm and an orientation direction of 22 mm to separate the orientation direction of the molding cavity into a first cavity and a second cavity whose volume ratio is 1:3; the molding cavity has a depth of 100 mm; then the powder of the alloy A is filled into the first cavity and the powder of the alloy B is filled into the second cavity; and when the powder filling is finished, the copper separating board is removed and the filled powder is compacted in a magnet field for alignment.

The compact is sent into a sintering furnace in an environment containing oxygen below 1% and sintered at 1100° C. for 4 hours, followed by an aging treatment at 900° C. for 4 hours and at 500° C. for 3 hours to produce a semi-finished product of 60.3*40.8*15.4 mm. The powder of the alloy A is sintered to form an exterior layer having high coercive force; and the powder of the alloy B is sintered to form a medial layer having low coercive force.

Sample columns of D10*3.5 are respectively processed from the exterior layer and the medial layer of the magnet for magnetism test, the results of which are shown in table 1.

TABLE 1

| | Br | Hcb | Hcj | (BH)max | Hk | |
|---|---|---|---|---|---|---|
| | kGs | kOe | kOe | MGOe | kOe | Hk/Hcj |
| A | 13.25 | 12.88 | 24.08 | 42.42 | 23.59 | 0.98 |
| B | 13.9 | 13.53 | 18.1 | 47.09 | 17.67 | 0.98 |

A first sample column of D10*3.5 is processed with the center around the boundary between the exterior layer and the medial layer; a second sample column of D10*3.5 having coercive force of 24.08 is processed in the exterior layer; and a third sample column of D10*3.5 having coercive force of 18.1 is processed in the medial layer. The first, second, and third sample columns are tested about irreversible magnetic flux respectively at 120° C. and 150° C. for 2 hours. The tested samples are all layed onto an iron board to be tested, wherein the first sample column has a side of the medial layer close to the iron board. The results are shown in Table 2

TABLE 2

| | 20° C. | 120° C. | flux loss | 150° C. | flux loss |
|---|---|---|---|---|---|
| number | flux(*1)/mwb | flux(*1)/mwb | rate(%) | flux(*1)/mwb | rate(%) |
| 1 | 0.201 | 0.201 | 0 | 0.200 | 0.870 |
| 2 | 0.195 | 0.195 | 0 | 0.194 | 0.717 |
| 3 | 0.207 | 0.205 | 0.677 | 0.181 | 12.521 |

### Embodiment 2

### 44H-38UH NdFeB Magnet Having Gradient Coercive Force

Raw materials having a component of Nd₂₀Pr_{5.2}Dy₆Co₁Cu_{0.1}Ga_{0.15}B_{0.97}Nb_{0.1}Feᵣₑₛₜ are smelted to form an alloy A in a vacuum strip continuous casting furnace, and raw materials having a component of Nd_{24.8}Pr_{4.5}Dy_{2.4}Co_{0.8}Cu_{0.1}Ga_{0.1}Al_{0.15}B_{0.95}Nb_{0.1}Feᵣₑₛₜ are smelted to form an alloy B in the vacuum strip continuous casting furnace. Then flakes of the alloy A and the alloy B are respectively processed with hydrogen pulverization in a hydrogen treatment furnace, and thereafter, in a protective anaerobic environment of N₂, processed with fine pulverization via a jet mill to produce powder having a particle size of 3.5 μm. The powder is molded in a parallel magnetic orienting and molding device having an environment containing oxygen below 1%, wherein a molding cavity of 75 mm in length and 50 mm in width firstly has a height of 5.5 mm filled with the powder of the alloy A and then a height of 16.5 mm filled with the powder of the alloy B. When the powder filling is finished, the filled powder is compacted in a magnet field for alignment.

The compact is sent into a sintering furnace in an environment containing oxygen below 1% and sintered at 1090° C. for 4 hours, followed by an aging treatment at 900° C. for 3 hours and at 540° C. for 4 hours to produce a semi-finished product of 62.6*41.7*15 mm. The powder of the alloy A is sintered to form an exterior layer having high coercive force; and the powder of the alloy B is sintered to form a medial layer having low coercive force.

Sample columns of D10*3.5 are respectively processed from the exterior layer and the medial layer of the magnet to be tested about magnetism. Table 3 shows results of the magnetism test.

TABLE 3

| | Br | Hcb | Hcj | (BH)max | Hk | | density |
|---|---|---|---|---|---|---|---|
| | kGs | kOe | kOe | MGOe | kOe | Hk/Hcj | g/cm\hat{ }3 |
| A | 12.46 | 12.15 | 27.47 | 37.65 | 23.97 | 0.87 | 7.63 |
| B | 13.36 | 13.05 | 18.19 | 43.74 | 17.39 | 0.95 | 7.6 |

A first sample column of D10*3.5 is processed with the center around the boundary between the exterior layer and the medial layer; a second sample column of D10*3.5 having coercive force of 27.47 is processed in the exterior layer; and a third sample column of D10*3.5 having coercive force of 18.19 is processed in the medial layer. The first, second, and third sample columns are tested about irreversible magnetic flux at 180° C. for 2 hours. The tested samples are all laid onto an iron board to be tested, wherein the first sample column has a side of the medial layer close to the iron board. The results are shown in Table 4.

TABLE 4

| | 20° C. | 150° C. | flux loss | 180 ° C. | flux loss |
|---|---|---|---|---|---|
| number | flux(*1)/mwb | flux(*1)/mwb | rate(%) | flux(*1)/mwb | rate(%) |
| 1 | 0.194 | 0.194 | 0 | 0.192 | 1.081 |
| 2 | 0.187 | 0.187 | 0 | 0.186 | 0.935 |
| 3 | 0.201 | 0.153 | 23.56 | 0.106 | 46.946 |

### Embodiment 3

### 42SH-48H-42SH NdFeB Magnet Having Gradient Coercive Force

Raw materials having a component of Nd₂₀Pr_{5.5}Dy_{4.5}Co₂Cu_{0.15}Ga_{0.1}Al_{0.2}B₁Nb_{0.1}Feᵣₑₛₜ are smelted to form an alloy A in a vacuum strip continuous casting furnace, and raw materials having a component of Nd₂₁Pr₆Dy_{2.5}Co₁Cu_{0.1}Ga_{0.1}B₁Nb_{0.1}Feᵣₑₛₜ are smelted to form an alloy B in the vacuum strip continuous casting furnace. Then flakes of the alloy A and the alloy B are respectively processed with hydrogen pulverization in a hydrogen treatment furnace, and thereafter, in a protective anaerobic environment of N₂, processed with fine pulverization via a jet mill to produce powder having a particle size of 3.6 μm.

The powder is molded in a vertical magnetic orienting and molding device having an environment containing oxygen below 1%, wherein two copper separating boards both having a length of 71.9 mm, a height of 105 mm and a thickness of 0.5 mm are pre-provided in a molding cavity having a length of 72 mm and an orientation direction of 22 mm to separate the orientation direction of the molding cavity into a first cavity, a second cavity and a third cavity whose volume ratio is 1:3:1; the molding cavity has a depth of 100 mm; then the powder of the alloy A is filled into the first cavity and the third cavity and the powder of the alloy B is filled into the second cavity; and when the powder filling is finished, the two copper separating boards are removed and the filled powder is compacted in a magnet field for alignment.

The compact is sent into a sintering furnace in an environment containing oxygen below 1% and sintered at 1100° C. for 5 hours, followed by an aging treatment at 900° C. for 4 hours and at 500° C. for 3 hours to produce a semi-finished product of 60.3*40.8*15.4 mm. The powder of the alloy A is sintered to form two exterior layers having high coercive force; and the powder of the alloy B is sintered to form a medial layer having low coercive force.

Sample columns of D10*3.5 are respectively processed from the exterior layer and the medial layer of the magnet to be tested about magnetism. Table 5 shows results of the magnetism test.

TABLE 5

| | Br | Hcb | Hcj | (BH)max | Hk | |
|---|---|---|---|---|---|---|
| | kGs | kOe | kOe | MGOe | kOe | Hk/Hcj |
| A | 13.23 | 12.88 | 23.59 | 42.42 | 23.12 | 0.98 |
| B | 13.92 | 13.53 | 17.98 | 47.05 | 17.62 | 0.98 |

A first sample column of D10*14 is processed with the center around the medial layer; a second sample column of D10*14 having coercive force of 23.59 is processed in the exterior layer; and a third sample column of D10*14 having coercive force of 17.98 is processed in the medial layer. The first, second, and third sample columns are tested about irreversible magnetic flux respectively at 150° C. for 2 hours. The tested samples are all laid onto iron boards to be tested. The results are shown in Table 6.

TABLE 6

| | 20° C. | 120° C. | flux loss | 150° C. | flux loss |
|---|---|---|---|---|---|
| number | flux(*1)/mwb | flux(*1)/mwb | rate(%) | flux(*1)/mwb | rate(%) |
| 1 | 0.313 | 0.313 | 0 | 0.307 | 1.680 |
| 2 | 0.303 | 0.303 | 0 | 0.301 | 0.577 |
| 3 | 0.321 | 0.319 | 0.65 | 0.275 | 14.286 |

### Embodiment 4

### 42H-36UH NdFeB Magnet Having Gradient Coercive Force

Raw materials having a component of Nd₂₂Pr₆Dy₆Co₁Cu_{0.1}Ga_{0.1}B₁Nb_{0.1}Ti_{0.1}Feᵣₑₛₜ are smelted to form an ingot A of 20 mm in width in a vacuum induction furnace, and raw materials having a component of Nd_{24.8}Pr₄Dy₃Co_{0.4}Cu_{0.15}Ga_{0.1}Al_{0.25}B₁Nb_{0.1}Feᵣₑₛₜ are smelted to form an ingot B of 20 mm in width in the vacuum induction furnace. Then the ingot A and the ingot B are respectively pulverized by a cyclone separator, and thereafter processed with fine pulverization by a jet mill to produce powder having a particle size of 3.8 μm. The powder is added with 1% antioxidants and molded in a vertical magnetic orienting and molding device, wherein a copper separating board having a length of 64.9 mm, a height of 95 mm and a thickness of 0.5 mm is pre-provided in a molding cavity having a length of 65 mm and an orientation direction of 24 mm to separate the orientation direction of the molding cavity into a first cavity and a second cavity whose volume ratio is 1:4; the molding cavity has a depth of 90 mm; then the powder of the ingot A is filled into the first cavity and the powder of the ingot B is filled into the second cavity; and when the powder filling is finished, the copper separating board is removed and then the filled powder is compacted in a magnet field for alignment.

The compact is sent into a sintering furnace having an environment containing oxygen below 1% and sintered at 1100° C. for 5 hours, followed by an aging treatment at 900° C. for 4 hours and at 500° C. for 3 hours to produce a semi-finished product of 53.9*38.7*17 mm. The powder of the ingot A is sintered to form an exterior layer having high coercive force; and the powder of the ingot B is sintered to form a medial layer having low coercive force.

Sample columns of D10*3.5 are respectively processed from the exterior layer and the medial layer of the magnet to be tested about magnetism. Table 7 shows results of the magnetism test.

TABLE 7

| | Br | Hcb | Hcj | (BH)max | Hk | |
|---|---|---|---|---|---|---|
| | kGs | kOe | kOe | MGOe | kOe | Hk/Hcj |
| A | 12.15 | 11.88 | 28.34 | 36.03 | 24.46 | 0.86 |
| B | 13.36 | 12.93 | 19.23 | 42.99 | 19 | 0.98 |

A first sample column of D10*3.5 is processed with the center around the boundary between the exterior layer and the medial layer; a second sample column of D10*3.5 having coercive force of 28.34 is processed in the exterior layer; and a third sample column of D10*3.5 having coercive force of 19.23 is processed in the medial layer. The first, second, and third sample columns are tested about irreversible magnetic flux respectively at 180° C. for 2 hours. The tested samples are all layed onto iron boards to be tested, wherein the first sample column has a side of the medial layer close to the iron board. The results are shown in Table 8.

TABLE 8

| | 20° C. | 150° C. | flux loss | 180° C. | flux loss |
|---|---|---|---|---|---|
| number | flux(*1)/mwb | flux(*1)/mwb | rate(%) | flux(*1)/mwb | rate(%) |
| 1 | 0.194 | 0.194 | 0 | 0.192 | 1.261 |
| 2 | 0.187 | 0.187 | 0 | 0.186 | 0.935 |
| 3 | 0.201 | 0.158 | 21.57 | 0.121 | 40.000 |

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and are subject to change without departure from such principles. Therefore, this invention includes all modifications of the invention that fall within the spirit and scope of the following claims.

### TECHNICAL UTILITY

The NdFeB magnet having gradient coercive force and its preparation method of the present invention use conventional materials used for producing permanent magnets, are produced by conventional devices and mature techniques and can be widely applied in the field of permanent magnet resistant to high temperature while generating positive results; and thus the present invention has a great market prospect and high technical utility.

1-10. (canceled)

11. A preparation method of a NdFeB magnet having gradient coercive force, comprising following steps of:
(1) preparing at least two alloys having components of R—Fe—B-M, wherein the alloys comprise at least alloy A and alloy B; R contains at least one rare earth element selected from Pr, Nd, Dy and Tb; M contains one or two more elements selected from Co, Cu, Ga, Nb, Al, Mn, Zr and Ti; and the weight percentage of M is below 5%, and the content of Dy and Tb in the alloy A is higher than the content of Dy and Tb in the alloy B, and the content of Dy and Tb in the alloy B is higher than the content of Dy and Tb in other alloys;
(2) pulverizing the alloy obtained from the step (1) into powder via a pulverizing device by at least one of following preparation methods of:
(a) putting alloy flakes respectively into a hydrogen treatment furnace for a hydrogen pulverization in a protective environment of inert gas or N₂ and then into a jet mill for a fine pulverization; and
(b) grinding and pulverizing alloy flakes respectively and then processing the alloy flakes with a fine pulverization via a jet mill;
(3) molding the powder obtained from the step (2) in a magnetic orienting and molding device, wherein at least one separating board is pre-provided therein; the powder is respectively filled into different separated cavities; and the separating board is removed until the powder filling is finished, wherein the powder of the alloy A is filled into at least an external cavity; and
(4) sending the compact into a sintering furnace to be sintered at 1000° C. to 1120° C. for 1 hour to 6 hours and subsequently processing with aging treatments at 850° C. to 950° C. for 1 hour to 6 hours and at 450° C. to 600° C. for 1 hour to 6 hours, so as to obtain a NdFeB magnet having gradient coercive force.

12. The preparation method, as claimed in claim 11, wherein particle sizes after the fine pulverization in the step (2) are between 3 μm and 4 μm.

13. The preparation method, as claimed in claim 11, wherein the step (3) further comprises filling the power obtained from the step (2) layer by layer along an orientation direction and then compacting the filled power in a magnetic field for alignment wherein the powder made of the alloy A is filled in an external layer of at least one side.

14. The preparation method, as claimed in claim 12, wherein the step (3) further comprises filling the power obtained from the step (2) layer by layer along an orientation direction and then compacting the filled power in a magnetic field for alignment wherein the powder made of the alloy A is filled in an external layer of at least one side.

15. The preparation method, as claimed in claim 13, wherein a ratio of a thickness filled by the powder made of the alloy A in the step (3) to a totally filled thickness is below 50%.

16. The preparation method, as claimed in claim 14, wherein a ratio of a thickness filled by the powder made of the alloy A in the step (3) to a totally filled thickness is below 50%.

17. The preparation method, as claimed in claim 11, wherein the magnetic orienting and molding device of the step (3) has a protection of inert gas or N₂, or has the powder added with antioxidants.

18. The preparation method, as claimed in claim 12, wherein the magnetic orienting and molding device of the step (3) has a protection of inert gas or N₂, or has the powder added with antioxidants.

19. The preparation method, as claimed in claim 13, wherein the magnetic orienting and molding device of the step (3) has a protection of inert gas or N₂, or has the powder added with antioxidants.

20. The preparation method, as claimed in claim 14, wherein the magnetic orienting and molding device of the step (3) has a protection of inert gas or N₂, or has the powder added with antioxidants.

21. The preparation method, as claimed in claim 15, wherein the magnetic orienting and molding device of the step (3) has a protection of inert gas or N₂, or has the powder added with antioxidants.

22. The preparation method, as claimed in claim 16, wherein the magnetic orienting and molding device of the step (3) has a protection of inert gas or N₂, or has the powder added with antioxidants.

23. A NdFeB magnet having gradient coercive force, comprising at least two NdFeB magnetic material layers having different coercive force, wherein the NdFeB magnet comprises a first exterior layer having high coercive force and at least a medial layer having low coercive force; a sintered layer connected said first exterior layer to said medial layer along an orientation direction.

24. The NdFeB magnet, as claimed in claim 23, wherein a plurality of said medial layers are connected with each other via said sintered layer along the orientation direction.

25. The NdFeB magnet, as claimed in claim 23, further comprising a second exterior layer which is connected to said medial layer provided externally via said sintered layer along the orientation direction.

26. The NdFeB magnet, as claimed in claim 24, further comprising a second exterior layer which is connected to said medial layer provided externally via said sintered layer along the orientation direction.

27. The NdFeB magnet, as claimed in claim 25, wherein said first exterior layer and said second exterior layer are made of identical materials.

28. The NdFeB magnet, as claimed in claim 26, wherein said first exterior layer and said second exterior layer are made of identical materials.

29. The NdFeB magnet, as claimed in claim 27, wherein a ratio of a sum of thickness of said first exterior layer and said second exterior layer to a total thickness is below 50%.

30. The NdFeB magnet, as claimed in claim 28, wherein a ratio of a sum of thickness of said first exterior layer and said second exterior layer to a total thickness is below 50%.
